(19) United States
(12) Patent Application Publication
(10) Pub. No.: US 2019/0118271 A1
(43) Pub. Date: Apr. 25, 2019

(54) Deburr-It Bit

(71) Applicant: Paul Joseph Reinbold, Portland, ME (US)

(72) Inventor: Paul Joseph Reinbold, Portland, ME (US)

(21) Appl. No.: 15/732,324

(22) Filed: Oct. 25, 2017

(51) Int. Cl. B23B 51/10

(52) U.S. Cl. CPC B23B 51/103

(57) ABSTRACT

The Deburr-It Bit is a versatile tool bit designed to be used manually with smaller size circular hollow ridged tubing or with a motorized drill during the installation of all types and sizes of circular hollow ridged tubing. The function of the Deburr-It Bit is to remove burr that is formed on said tubing when the tubing is cut with various types of saws and cutting tools. In most cases, the removal of burr allows the circular hollow ridged tubing to easily slip into the manufactured fitting orifice found on all fittings which could include elbows, valves, couplings, adaptors, and most types of connectors. It should also be noted here, that removal of burr, on the inside edge of circular hollow ridged tubing, is necessary to have a smooth unrestricted surface for the best fluid flow possible. The purpose of this Deburr-It Bit is to completely remove burr from the inside edge of said tubing, the outside edge of said tubing, and release burr waste debris particles to the atmosphere at the same time during said bit rotation. What is unique is the beveled circular double-wall V-shaped abrasion cavity surfaces of the Deburr-It Bit, that when in contact with said tubing, will remove the burr from both the inside edge of circular hollow ridged tubing and outside edge of circular hollow ridged tubing at the same time and in a shorter amount of time, resulting in two smooth unrestricted tubing surfaces. There is no need for expensive machinery.

### DISCUSSION OF PRIOR ART

Prior art is replete with designs and functionalities of very efficient tools that can deburr circular hollow ridged tubing with little effort to achieve effective results on the tubing edge to maximize air-tight and water-tight connections with most types of fittings. Plumbing, irrigation, and vacuum installations require flawless connections in all residential and commercial construction projects. Prior Art has many examples of deburring tools for various applications throughout industries, such as, mechanical, automotive, construction, metal forming and shaping, and manufacturing. Many of these tools are not applicable to inexpensive hand or motorized tools; they require costly machinery; they cannot produce the desired tubing in a timely manner. Some Prior Art examples can only deburr ridged plastics, small thickness flexible tubing, and deburr only one edge at a time making this Deburr-it Bit a unique tool in many aspects. Prior art is also replete with respect to burr debris particle removal from the tool and tubing surfaces making contact with a deburring device, either concurrently during the deburring process, or is not considered at all, but should be.

With respect to U.S. Pat. No. 5,020,401 A, a Universal plastic-pipe tool the field of the invention states that this tool is designed to chamfer flexible plastic tubing that has been manufactured and wound into large coils for storage and transportation. This coiling process, of flexible plastic tubing often results in the tubing becoming “oval”, in cross-section, and not remaining “circular” as intended when extruded in the manufacturing process. None of the features and methods indicates any appropriate application to circular ridged plastic tubing and the deburring of such.

With respect to U.S. Pat. No. 5,716,171 A, a Deburring tool the field of the invention states that this tool has a single triangular blade, for deburring holes or bores in uneven surfaces, which will pivot freely about a circular axis supplied by a rotatable tool. The summary also states that this tool can be used on any size hole with uneven surfaces with application examples of carrier trunnions, axil tubes, and spreader holes. This tool has set screws, blades, barrels, reinforcing guides, and an axle, but only deburrs one uneven surface at a time. None of the features and methods indicate any appropriate application to circular ridged plastic tubing and the deburring of both the inside and outside tubing terminal ends at the same time.

With respect to patent no. EP 2392437 A1, a Cutting/trimming hand tool for low thickness flexible tubes the field of the invention states that this tool has a blade to cut, as close as possible to 90°, flexible plastic tubing of low thickness. A second trimming blade is also positioned at 90° to cutting blade to remove any burr along the outside edge of the tubing at the same time cutting is taking place. None of the features and methods indicates any appropriate application to circular ridged plastic tubing and the deburring of both the inside and outside tubing terminal ends at the same time.

With respect to U.S. Pat. No. 3,917,429 A Thin wall deburring tool the field of the invention states that this tool has cutting blades or stays that will function simultaneously together to deburr the inner and outer surface ends of both even and uneven tubing. This hand tool displays three bowed stays that are designed to remove burr from the inside and one thumb pressure operated stay to remove burr from the outer surface edge. In summary, there are only four stays that contact the surfaces of the tubing end at any one time. Therefore, due to the limited contact surface between this tool and the tubing end, manual rotation of the tool will dictate a multiple number of rotations would be necessary to accomplish the desired intent of this tool.

With respect to U.S. Pat. No. 3,754,832 A—Device for deburring plastic pipes the object of this invention is to deburr both the inner and outer circumference edges of tubing as a result of the cutting process. It has a plurality of contact points and that can be used with plastic tubing of various diameters. These contact points are situated on both the outside and inside of this cone shaped tool. Therefore, due to the limited contact surface between this tool and the tubing end manual rotation of the tool will dictate a multiple number of rotations would be necessary to accomplish the desired intent of this tool. The limitations of this hand tool are that only the inside of the tubing can be deburred when the cone of the tool is facing away from your hand. To deburr the outside of the tubing, the hand tool needs to be facing into your hand. Nowhere in the description or claims is there a reference to deburring materials other than plastics. This tool is not designed to deburr both the inside and outside tubing terminal ends at the same time.

With respect to U.S. Pat. No. 5,020,221 Pipe chamfer and deburring tool the field of the invention states that this hand tool has a single cutting blade that fits diagonally across the bore. The bore is where the pipe will slide into to reach the cutting blade. The cutting blade can be designed to specifications for a desired profile at the tubing end. The objectives of this hand tool were stated as follows: to evenly bevel PVC pipe and to evenly deburr PVC pipe. Again, there is only one blade with two cutting surfaces or two points of contact between the PVC Pipe and the cutting blade. This hand tool does not mention deburring or chamfering any materials other than PVC Pipe. One would infer that a hand tool, with only one blade with two cutting surfaces, additional physical pressure and time would be necessary.

### SUMMARY OF INVENTION

The use of PVC (Polyvinylchloride) in the commercial and residential building industry has become a standard material especially for trades where tubing and plastic fittings are joined together. The use of a PVC Adhesive and the joining of various fittings, valves, and tubing has become the standard for most plumbing, electrical, vacuum, irrigation, and other installations. The assumption that all fittings, valves, and tubing “easily” join together with PVC adhesive is a misnomer. When circular hollow ridged tubing is cut, by means of cutting tools, such as hacksaws and Pipe cutters, burr is formed. Depending on the cutting tool used, burr is seen and felt on both the inside edge and the outside edge of the said tubing terminal end. This burr must be removed so that the fitting and tubing joint make a fluid-tight and leak-proof connection.

There is a number of hand and motorized tools that have been introduced to remove this burr as indicated in the review of Prior Art. These hand or motorized tools have a few features in common namely: single blades to remove burr from tubing or multiple stays to scrape burr while cutting said tubing. Many of the tools are designed to remove burr from the outer edge or the inner edge of tubing, but not both edges.

In one instance, a hand tool, with three points of contact on the inner edge surface of tubing and one point of contact on the outer edge of tubing, proved to be able to remove burr on both edges of tubing at the same time, but with only four points of contact, multiple rotations of the tool would be necessary. In another instance, a rotatable hand tool made three points of contact on the outside edge of the PVC tubing using three scrapers or stays on the surface of the cone shaped tool. Then the cone shaped tool needs to be turned around so that three scraper or stays on the outside of the cone shaped tool deburrs the inside edges of the PVC tubing. Having to completely reposition this tool every time you need to deburr an inside edge and then switch to the outside edge of tubing is very inefficient.

The Deburr-It Bit is effective in either a clockwise or counter-clockwise rotation and can function by manual hand rotation or attached to a motorized drill. A removable central shaft can be added to the said bit to be used with a motorized drill in multiple locations, for example, either on a workbench or on a ladder deburring the tubing already fastened to a constructed surface. This Deburr-It Bit makes this invention a very effective tool for the plumbing, electrical, vacuum, irrigation, and industries that must have tubing and fitting joint connections that are fluid-tight and leak-proof.

To address the importance of deburring said tubing and consequently making connections that are fluid-tight and leak-proof, this Deburr-It Bit is designed to remove all burr from said tubing by making 360° points of contact on the inside surface of said tubing and at the same time making 360° points of contact on the outside surface of said tubing with only a single rotation. Said Bit will bevel and chamfer both sides of said tubing simultaneously creating smooth edges for making fluid-tight and leak-proof connections. As one could ascertain, burr debris particle removal needs to be addressed if any tool is to exhibit an effective and efficient protocol. The said bit is designed incorporating the Laws of Physics, and is capable of collecting and discharging to the atmosphere all burr debris particles from said bit during the deburring process.

The Deburr-It Bit will function, as described here in, with one hand holding said tubing and the other hand operating a motorized drill with said bit, at any drill speed. If said tubing was already attached to a building structure, deburring the edges of said tubing could easily be accomplished with one hand operating said drill with said bit.

Unique to this invention, is that said bit can be used with various sizes and composition types of circular hollow ridged tubing making it a versatile tool for various applications for manufacturing and construction industries. The abrasive material, used in the manufacture of the Deburr-It Bit V-shaped cavity walls, can be adjusted from very smooth to very course to accommodate abrasion of tubing of different compositions. Said tubing varies in size, composition, thickness, strength, and hardness. ANSI—the American National Standards Institute, in conjunction with AMSE—the American Society of Mechanical Engineers has agreed on a schedule classification for said tubing.

Abrasive materials can be either “natural abrasives” like flint, garnet, corundum, and diamond, or “artificial abrasives” like electro-corundum, silicon carbide, and synthetic diamonds. Abrasives all have characteristics of hardness, strength, grain grit, grain shape, abrasive power, and ductility that define and determine their application.

### DESCRIPTION OF DRAWINGS

FIG. 1. The said bit (A), its design and details are focused on its use, requirements, and applications for trades and industries that require circular hollow ridged tubing. The top planar surface (8) of said bit (A) and its abrasion V-shaped cavity (10) with abrasion cavity wall A (2), abrasion cavity wall B (4), and changeable shaft (6) is designed with a thickness, quantity, and quality of abrasive material to give strength to said bit (A). Ergonomic cupping shallows (16) can be added for comfortable manual hand rotation.

FIG. 2. The top view of said bit (A), details the top planar surface (8) and its abrasion V-shaped cavity (10) with abrasion cavity wall A (2), abrasion cavity wall B (4), and changeable shaft (6) for manual hand rotation or motorized drill attachment. The size, cavity diameter, and composition of abrasive material of said bit (A) can be adapted to any size, composition, and schedule of said tubing. Circumferential ergonomic cupping shallows (16) can be added for comfortable manual hand rotation.

FIG. 3. To permanently remove burr debris particles, said bit (A) has a non-abrasive circular burr receiving channel (14) functioning in conjunction with attached, periodically spaced non-abrasive circular debris hollows (12) is capable of discharging to the atmosphere all burr debris particles during the rotational deburring process.

FIG. 4. The cross-section in FIG. 4 details the planar surface (8), the circular V-shaped abrasive cavity (10) with circular abrasive cavity wall A (2) and circular abrasive cavity wall B (4), and a changeable circular shaft (6) for manual hand rotation or motorized drill attachment. A short distance from the outer edge on the top planar surface (8) of said bit (A) is a circular V-shaped abrasive cavity (10) that extends down to a non-abrasive burr receiving channel (14). The walls of this circular V-shaped cavity (10) are not perpendicular to the top planar surface (8), but are beveled towards each other and attached to a non-abrasive burr receiving channel (14) to which are attached non-abrasive circular debris hollows (12). Extending down through the Deburr-It Bit (A) is a changeable centered shaft (6) which will act as the attachment to a motorized drill or removed for hand held rotational deburring.

Burr debris particle removal begins with the insertion of said tubing into the V-shaped cavity (10) where said tubing will make contact with abrasive cavity wall A (2) and abrasive cavity wall B (4). Upon rotation of said bit (A), burr debris particles will fall into the circular non-abrasive burr receiving channel (14) due to gravity. With continued rotation of said bit (A), the particles are moved through said channel (14) and out through the circular debris hollows (12) to the atmosphere due to inertia, the lack of centripetal forces, and the unequal air pressure difference between the outer edge of the debris hollows (12) and the V-shaped cavity (10) due to Bernoulli's Principle.

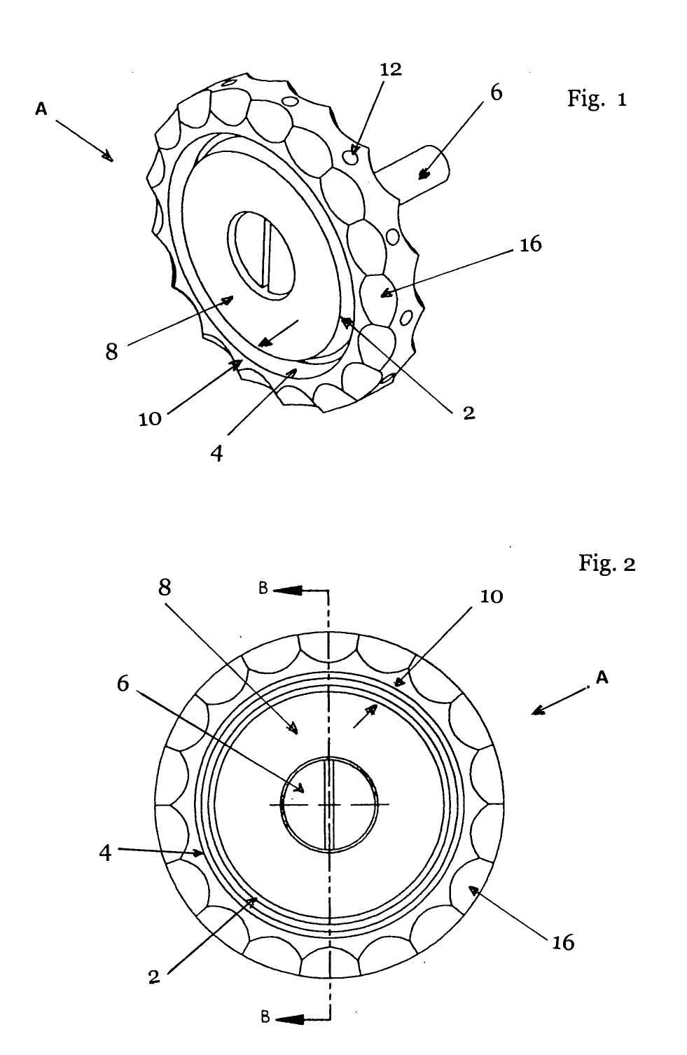

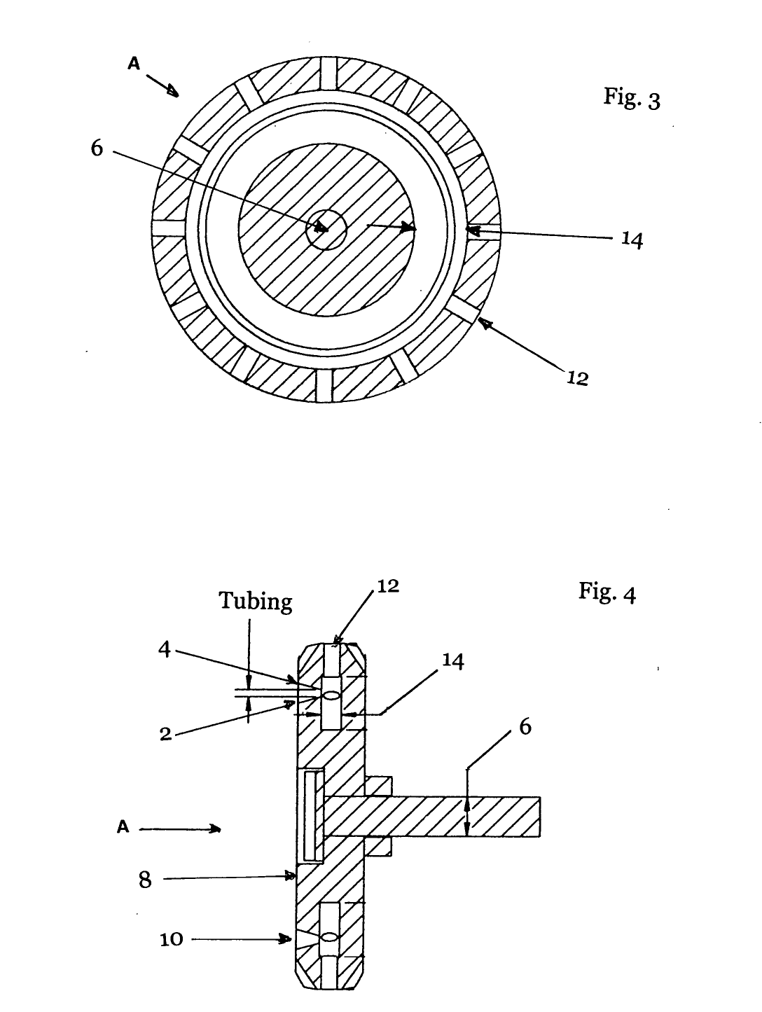

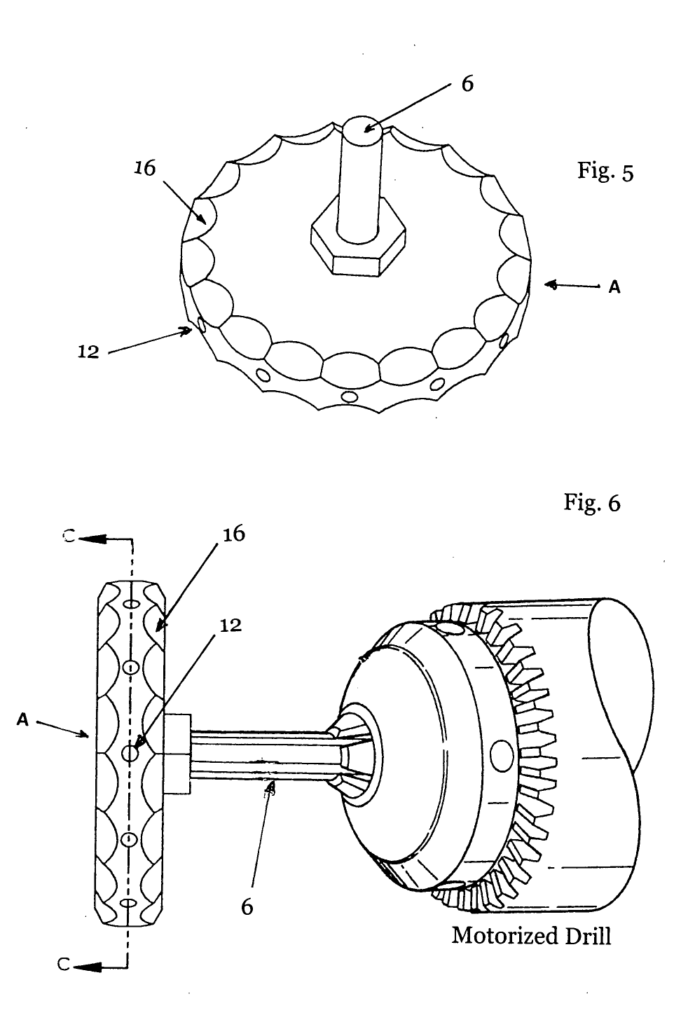

FIG. 5. A changeable circular shaft (6) extends down through the said bit (A), will become the attachment for rotational deburring where the diameter and length, will be determined by the size and composition of the circular hollow ridged tubing. For smaller size circular hollow ridged tubing, rounded and cupped edges (16) of the said bit (A) will make said bit ergonomically comfortable to hold and use as a hand tool without shaft (6) or a motorized attachment. Circular debris hollows (12), periodically spaced connects the circular non-abrasive burr receiving channel (14) to the atmosphere. As stated in FIG. 1, the outer terminal ends of the periodically spaced non-abrasive circular debris hollows (12) are shown and referenced.

FIG. 6. A changeable circular shaft (6) extends through the said bit (A) to a motorized drill. As stated in FIG. 1, the outer terminal ends of the periodically spaced non-abrasive circular debris hollows (12) are shown and referenced. As stated in FIG. 5, for smaller size circular hollow ridged tubing, rounded and cupped edges (16) of the said bit (A) will make said bit ergonomically comfortable to hold and use as a hand tool are also shown and referenced.

I claim:

1. A deburr-it bit (A) comprising a single circular member, made of abrasive material, with a single changeable centered shaft (6) for rotatable functionality to a motorized drill, capable of removing burr from both the inside edge of circular hollow ridged tubing and the outside edge of said tubing at the same time; said bit (A) having a circular V-shaped abrasive cavity (10) is capable of accepting the insertion of said tubing creating static friction surface contact; where said tubing makes contact with circular abrasive cavity wall A (2) is capable, due to overcoming the resistive force of static friction between said tubing, of deburring the inside edge of said tubing with hand or motorized rotation; where said tubing makes contact with circular abrasive cavity wall B (4) is capable, due to overcoming the resistive force of static friction between said tubing, of deburring the outside edge of said tubing with hand or motorized rotation; said circular abrasive cavity wall A (2) is capable of making 360° of static frictional contact with the inside edge of said tubing and, at the same time, circular abrasive cavity wall B (4) is capable of making 360° of static frictional contact with the outside edge of said tubing; where rotation of said bit (A) results in kinetic friction where surface roughness and deformations are altered and results in circular, unrestricted, smooth edged surfaces on said tubing.

2. A deburr-it bit (A), as claimed in claim 1, further comprising a single circular member having a 360° circular non-abrasive burr receiving channel (14) immediately below and attached to said cavity walls (2, 4), parallel to the planar surface (8), is capable of receiving burr debris particles; said bit (A) having non-abrasive periodically spaced circular debris hollows (12) connected to said channel (14) are capable of removing burr debris particles from said channel (14) to the atmosphere upon rotation of said member bit (A) with attachment shaft (6) to a motorized drill or hand rotation; said bit (A) is capable of collecting burr debris particles in circular burr receiving channel (14) due to the Laws of Motion and Gravity; said bit (A), with periodically spaced circular debris hollows (12) attached to said channel (14) is capable of removing burr debris particles upon rotation of the single member bit (A) by a motorized drill or hand rotation, due to Bernoulli's Principle of unequal fluid pressure differences created due to rotation of said bit (A) where higher fluid pressure would be present entering circular V-shaped abrasive cavity (10) and lower fluid pressure would be present at the outer terminal ends of periodically spaced circular debris hollows (12); said member bit (A), with periodically spaced circular debris hollows (12) attached to said channel (14) is capable of removing burr debris particles upon rotation of the single member bit (A) by a motorized drill or hand rotation, due to inertia and the lack of centripetal forces.

3. A deburr-it bit (A), as claimed in claimed in claim 1, with a single circular V-shaped cavity (10) and a single changeable circular shaft (6) with rotatable functionality to a motorized drill or hand rotation, is capable, due to overcoming the resistive force of static friction between said tubing, of creating circular, unrestricted, smooth edged surfaces on said tubing; said bit (A) is capable of making the joint, between a fitting and said tubing, a fluid-tight and leak-proof connection, where fluid-tight and leak-proof connections require both the fitting orifice and said tubing outside diameter to be circular, smooth, burr free, and able to accept an application of a cementing adhesive compound.

4. A single member circular deburr-it bit (A), as claimed in claim 1, additionally having a changeable center shaft (6) for attachment to a motorized drill where said bit (A) rotation, clockwise or counter-clockwise, will not alter the deburring process, effectiveness, efficiency, and burr debris particle removal resulting in smooth surfaces of said tubing; where said bit (A) having a changeable center shaft (6) for attachment to a motorized drill where said bit (A) speed of rotation is capable of speeding up the deburring process to save time and labor cost;
where said tubing is attached to a solid structure, said bit (A) is capable of placement of the V-shaped cavity (10) in a dominant position to accept said tubing can be used with one hand operating a motorized drill or manual hand rotation.

5. A deburr-it bit (A), with ergonomically designed cupping shallows (16), without shaft (6), for manual hand rotation, is capable of removing burr from both the inside edge and outside edge of said tubing at the same time; where said bit (A) when rotated, clockwise or counter-clockwise, will not alter the deburring process, effectiveness, efficiency, and the resulting smooth surfaces of said tubing; where said bit (A) is capable of being used with one hand holding the said tubing and the other hand rotating the said bit (A).
